(19) United States
(12) Patent Application Publication
(10) Pub. No.: US 2022/0278781 A1
(43) Pub. Date: Sep. 1, 2022

(54) METHOD FOR CONFIGURATION OF HARQ-ACK FEEDBACK

(71) Applicant: GUANGDONG OPPO MOBILE TELECOMMUNICATIONS CORP., LTD., Guangdong (CN)

(72) Inventors: Hao LIN, Neuilly-sur-Seine (FR); Zuomin WU, Guangdong (CN)

(73) Assignee: GUANGDONG OPPO MOBILE TELECOMMUNICATIONS CORP., LTD., Guangdong (CN)

(21) Appl. No.: 17/749,156

(22) Filed: May 20, 2022

Related U.S. Application Data
(63) Continuation of application No. PCT/CN2020/130674, filed on Nov. 20, 2020.
(60) Provisional application No. 62/938,950, filed on Nov. 21, 2019.

(51) Int. Cl. H04L 1/18; H04L 5/00

(52) U.S. Cl. CPC H04L 1/1861; H04L 1/1812; H04L 5/0055

(57) ABSTRACT

A method of operating a user equipment, the method comprising: receiving a Physical Downlink Shared Channel (PDSCH) transmission and transmitting a Hybrid Automatic Report Request (HARQ) feedback in response to the PDSCH transmission, wherein the HARQ feedback comprises a one-shot HARQ feedback.

### CROSS-REFERENCE TO RELATED APPLICATIONS

This application is a continuation of international PCT application serial no. PCT/CN2020/130674, filed on Nov. 20, 2020, which claims the priority benefit of U.S. application No. 62/938,950 filed on Nov. 21, 2019. The entirety of each of the above mentioned patent applications is hereby incorporated by reference herein and made a part of this specification.

### TECHNICAL FIELD

The present invention relates to next generation mobile communication, in particular to the configuration of HARQ-ACK feedback configuration for one-shot HARQ feedback in NR-U.

### BACKGROUND

Part of the development of New Radio (NR) technology is that in addition to conventionally used licensed spectrum also an unlicensed spectrum is used; this aspect of NR technology is called NR-U.

While in the licensed spectrum, a frequency or a range of frequencies is clearly attributed to a specific service and that service alone, i.e. to a given communication system equipped with the authorization to use this frequency or range of frequencies, this is not the case for the unlicensed spectrum.

The unlicensed spectrum is a shared spectrum, that is, different from the licensed spectrum, use thereof is not restricted to communication system equipped with an authorization. In contrast, the communication equipment in different communication systems can use the spectrum as long as it meets the regulatory requirements set by the country or region on the spectrum and does not need to apply for a proprietary spectrum authorization from the government.

While this clearly has certain advantages, such as the possibility to increase the used bandwidth as desired and required, this advantage does not come without a price. Due to the uncertainty which parties are intending to use or are using the unlicensed spectrum, it is likely to come to overlaps. Such overlaps clearly represent a performance and reliability issue and thus have to be addressed appropriately.

In order to allow various communication systems using the unlicensed spectrum for wireless communication to coexist friendly in said part of the spectrum, regulatory requirements can present a solution. In fact, some countries or regions specify regulatory requirements that must be met to use the unlicensed spectrum. One example of such a regulatory requirement is the principle of “Listen Before Talk” (LBT). This principle requires that the device needs to perform channel sensing before transmitting the signal on the channel. Only when the LBT outcome shows that the channel is idle, the device can perform signal transmission; otherwise, the device cannot perform signal transmission. Moreover, to ensure fairness and to avoid that a device uses a channel indefinitely, that is, effectively blocks the channel, once a devices successfully occupies the channel, the transmission duration cannot exceed the Maximum Channel Occupancy Time (MCOT).

### BRIEF DESCRIPTION OF THE DRAWINGS

Aspects of the present invention, which are present for better understanding the inventive concepts but which are not to be seen as limiting the invention, will now be described with reference to the figures in which:

FIG. 1 shows an example of a wireless communication network.

FIG. 2 shows an exemplary configuration of a user equipment.

### DETAILED DESCRIPTION

In NR-U, a user equipment (UE) can be configured with one-shot Hybrid Automatic Repeat Request (HARQ) feedback. HARQ is a combination of high-rate forward error-correcting code with Automatic Repeat Request (ARID), error-control. One-shot HARQ refers to a situation in which the feedback provided to a HARQ request is no provided one-by-one for each request but instead the feedback of a number of requests is bundled and provided together in one transmission, hence the name “one-shot”.

In other words, the present disclosure includes a method of operating a user equipment, the method comprising: receiving a Physical Downlink Shared Channel, PDSCH, transmission and transmitting a Hybrid Automatic Report Request, HARQ, feedback in response to the PDSCH transmission, wherein the HARQ feedback comprises a one-shot HARQ feedback.

More specifically, there are two types of one-shot HARQ feedback based on whether a New Data Identifier (NDI) is configured to be part of one-shot HARQ feedback or not. This NDI is a value indicating whether the transmitted data is new data or whether the transmitted data is re-transmitted data. The two types of one-shot HARQ feedback are:
Type A: NDI is configured to be part of one-shot HARQ feedback.

In this case, the latest NDI value detected by the UE is reported along with HARQ-ACK (ACK standing for ‘acknowledgment’) for the corresponding HARQ process ID. The UE assumes NDI=0 if there is no prior NDI value for the HARQ process.
Type B: NDI is not configured to be part of one-shot HARQ feedback.

In this case, NDI value is not reported along with HARQ-ACK for the corresponding PDSCH. UE is expected to reset HARQ-ACK state, either as discontinuous transmission (DTX) or negative acknowledgement (NACK), for a HARQ process ID once ACK is reported for the same HARQ process ID in the previous feedback.

In other words, the method disclosed in the present disclosure may optionally be configured such that the one-shot HARQ feedback comprises at least one of the following two types: a first type in which a NDI is part of the one-shot HARQ feedback and a second type in in which the NDI is not part of the one-shot HARQ feedback.

Moreover, the method disclosed in the present disclosure may optionally be configured such that the NDI value is reported along with the HARQ-ACK.

Furthermore, the method disclosed in the present disclosure may optionally be configured such that the configuration in which the NDI is not part of the one-shot HARQ feedback is used.

In Type A, if the maximum number of codewords for downlink transmission is two, two NDIs should be reported along with corresponding HARQ-ACKs for the corresponding HARQ process ID.

In other words, the method disclosed in the present disclosure may optionally be configured such that the maximum number of codewords is two and two New Data Identifier (NDI), are reported.

However, how to perform one-shot HARQ feedback if spatial bundling for HARQ feedback is configured is not discussed. Spatial bundling refers to bundling across multiple codewords within a subframe or in other words bundling of HARQ-ACK feedback for the PDSCH codewords corresponding to different spatially multiplexed streams.

In other words, the method disclosed in the present disclosure may optionally be configured such that the spatial bundling is configured for the HARQ feedback.

The present disclosure addresses this issue, among others. Particularly, the present disclosure includes at least parts of the following contents.

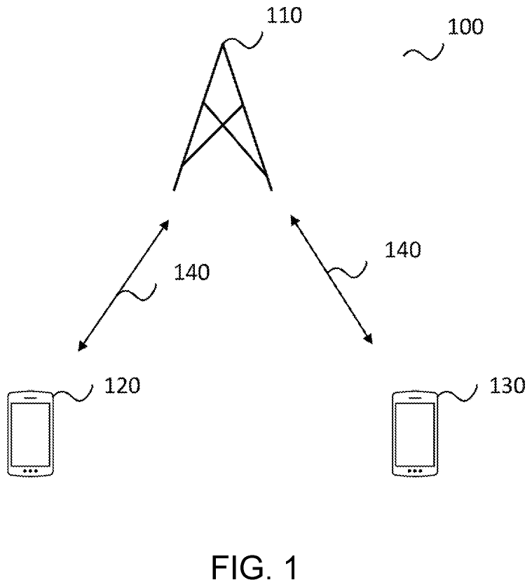

FIG. 1 shows an example of a wireless communication network 100 comprising one network node 110, a UE 120, and a UE 130. A network node and a UE may generally be considered a device or node adapted for wireless and/or radio (and/or microwave) frequency communication, and/or for communication utilizing an air interface, e.g. according to a communication standard. The network node 110 may be any kind of network device or radio node of a wireless communication network, such as a base station and/or eNodeB (eNB) and/or gNodeB (gNB) and/or relay node and/or micro or nano or pico or femto node and/or other node. The exemplary wireless communication network 100 of FIG. 1 comprises one network node and two UEs. This is, however, not limiting and the wireless communication network 100 may comprise more or less network nodes and UEs.

The UEs 120 and 130 may represent an end device for communication utilizing the wireless communication network, and/or be implemented as a UE according to a communication standard such as LTE, NR, NR-U or the like. Examples of UEs may comprise a phone such as a smartphone, a personal communication device, a mobile phone or terminal, a computer, in particular a laptop, a sensor or a machine with radio capability (and/or adapted for the air interface), in particular for MTC (Machine-Type-Communication, sometimes also referred to M2M, Machine-To-Machine), D2D (Device-to-Device), a RSU (Road Side Unit), or a vehicle adapted for wireless communication. A UE or terminal may be mobile or stationary.

The network node 110 is able to send any kind of Downlink (DL) data to the UEs 120 and 130 via communication links 140 and the UEs 120 and 130 are able to send any kind of Uplink (UL) data to the network node 110 via communication links 140 (such as LTE, NR, NR-U or the like).

Signaling may generally comprise one or more signals and/or one or more symbols. Control information or a control information message or corresponding signaling (control signaling) may be transmitted on a control channel, e.g. a physical control channel, which may be a downlink channel. Acknowledgement signaling, e.g. as a form of HARQ feedback reporting, may be transmitted by a UE 120 or 130 on a PUCCH (Physical Uplink Control Channel) and/or PUSCH (Physical Uplink Shared Channel) and/or a HARQ-specific channel to the network node 110.

Specifically, if both of the UEs 120 and 130 do not use the licensed spectrum, but instead use the unlicensed spectrum for communication with the network node 110, there is the need for ensuring that the two UEs 120 and 130 do not interfer with each other and thus hinder communication altogether. To this end, Listen Before Talk (LBT) can provide a solution by ensuring that no channel is used by a UE that is already in use by another UE.

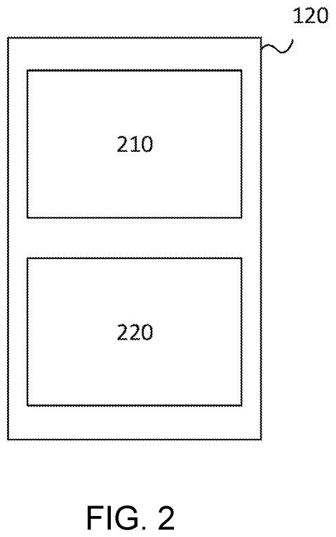

FIG. 2 shows an exemplary configuration for the UE 120. The configuration for the UE 130 is the same as for UE 120 and a detailed description about the configuration for the UE 130 is here omitted for conciseness. The UE 120 may comprise a processor 210 and a memory 220. The processor 210 may be a processing circuitry (which may also be referred to as control circuitry) which may comprise a controller connected to the memory 220. Any module of the UE 120, e.g. a communication module or determining module, may be implemented in and/or executable by, the processing circuitry 210, in particular as module in the controller. The UE 120 may also comprise radio circuitry (not shown) providing receiving and transmitting or transceiving functionality, e.g. one or more transmitting sections and/or receivings sections and/or transceivers, wherein the radio circuitry is connected or connectable to the processing circuitry 210. An antenna circuitry (not shown) of the UE 120 may be connected or connectable to the radio circuitry to collect or send and/or amplify signals. The UE 120 may be adapted to carry out any of the methods for operating the user equipment disclosed herein; in particular, it may comprise corresponding circuitry, e.g. processing circuitry, and/or modules.

In NR, the UE can be configured with spatial bundling of HARQ-ACK feedback. If spatial bundling of HARQ-ACK feedback is configured, UE may thus report one HARQ-ACK information bit for two codewords.

In other words, the method disclosed in the present disclosure may be configured such that two independent NDI are reported with the spatial bundled HARQ-ACK.

In other words, the method disclosed in the present disclosure may further be configured such that the HARQ feedback reports one bit of HARQ information for two codewords.

As an example, if the two codewords both correspond to “ACK”, the UE shall report “ACK”; if at least one codeword corresponds to “NACK”, the UE shall report “NACK”.

In other words, the method disclosed in the present disclosure may be configured such that if at least one of the codewords is a NACK, the transmitted HARQ feedback is NACK.

This method therefore can be used to reduce the reported HARQ-ACK information bits.

In Type A one-shot HARQ feedback, if the maximum number of codewords for downlink transmission is two, two NDIs should be reported along with corresponding HARQ-ACKs for the corresponding HARQ process identifier (ID).

However, if spatial bundling for HARQ feedback is configured as well, at least one of the following options can be supported:
Option 1: two independent NDIs are reported along with the spatial bundled HARQ-ACK for the corresponding HARQ process ID.
Option 2: the configuration of spatial bundling is ignored, e.g. two independent NDIs are reported along with the corresponding HARQ-ACKs for the corresponding HARQ process ID.
Option 3: the NDI value is not reported along with HARQ-ACK for the corresponding HARQ process ID, e.g. the spatially bundled HARQ-ACK for the corresponding HARQ process ID is reported.
Option 4: Type B one-shot HARQ feedback is used, e.g. the HARQ-ACKs for the corresponding HARQ process ID are reported.
Option 5: two independent NDIs are reported along with repeated spatially bundled HARQ-ACK for two codewords for the corresponding HARQ process ID.

In other words, the method disclosed in the present disclosure may be configured such that the configuration of spatial bundling is ignored.

Put differently, the method disclosed in the present disclosure may be configured such that two independent NDI are reported along with the repeated spatial bundled HARQ-ACK for two codewords.

A further optional configuration is that the configuration of spatial bundling does not apply to Type A one-shot HARQ feedback and/or Type B one-shot HARQ feedback.

In other words, the method disclosed in the present disclosure may be configured such that the configuration of spatial bundling does not apply to the types of one-shot HARQ feedback in which the NDI is part of the one-shot HARQ feedback.

Another further optional configuration is that the configuration of spatial bundling applies to at least one of the following HARQ feedback types: semi-static HARQ feedback (or Type-1 HARQ-ACK codebook), dynamic HARQ feedback (or Type-2 HARQ-ACK codebook), enhanced group based dynamic HARQ feedback (or enhanced Type-2 HARQ-ACK codebook).

In other words, the method disclosed in the present disclosure may be configured such that the configuration of spatial bundling applies to at least one of the following HARQ feedback types: semi-static HARQ feedback, dynamic HARQ feedback, and enhanced group based dynamic HARQ feedback.

Another optional configuration would be that the UE is not expected to be configured with Type A one-shot HARQ feedback and spatial bundling for HARQ feedback simultaneously.

In other words, the method disclosed in the present disclosure may be configured such that the first type of one-shot HARQ feedback and spatial bundling are not used simultaneously.

Moreover, in another optional configuration, all the options in the present disclosure can be included in a configuration of Radio Resource Control (RRC), if there is not mutual exclusion thereof.

In other words, the method disclosed in the present disclosure may be configured such that the method is RRC configured.

Alternative configurations of the method disclosed in the present disclosure include the following configurations.

The method disclosed in the present disclosure may be configured such that the PDSCH transmission corresponds to a HARQ process ID.

The method disclosed in the present disclosure may be configured such that the PDSCH transmission comprises an amount of codewords or an amount of transport blocks.

The method disclosed in the present disclosure may be configured such that the amount of codewords or transport blocks comprises at least one or two.

The method disclosed in the present disclosure may be configured such that the one-shot HARQ feedback comprises an HARQ-ACK codebook, wherein the HARQ-ACK codebook comprises at least one of the followings: a first HARQ-ACK information bit or a second HARQ-ACK information bit, and wherein the first and/or the second HARQ-ACK information bit are for the HARQ process ID.

The method disclosed in the present disclosure may be configured such that the first HARQ-ACK information bit comprises at least one of the followings: a first type of HARQ-ACK information bit and a second type of HARQ-ACK information bit.

The method disclosed in the present disclosure may be configured such that wherein the first type of HARQ-ACK information bit comprises an HARQ-ACK information bit for a first codeword or for a first transport block of the HARQ process ID.

The method disclosed in the present disclosure may be configured such that the second type of HARQ-ACK information bit comprises: a binary AND operation of an HARQ-ACK information bit for a first codeword or a first transport block of the HARQ process ID and an HARQ-ACK information bit for a second codeword or a second transport block of the HARQ process ID.

The method disclosed in the present disclosure may be configured such that the second HARQ-ACK information bit comprises an HARQ-ACK information bit for the second codeword or the second transport block of the HARQ process ID.

The method disclosed in the present disclosure may be configured such that the first HARQ-ACK information bit is the second type of HARQ-ACK information bit when a first parameter is configured.

The method disclosed in the present disclosure may be configured such that the first HARQ-ACK information bit is the first type of HARQ-ACK information bit when the first parameter is not configured.

The method disclosed in the present disclosure may be configured such that the first parameter is relevant to spatial bundling.

The method disclosed in the present disclosure may be configured such that the HARQ-ACK codebook comprises the second HARQ-ACK information bit, when the first parameter is not configured.

The method disclosed in the present disclosure may be configured such that the HARQ-ACK codebook may be configured to further comprise a first New Data Identifier (NDI) value and/or a second NDI value corresponding to the HARQ process ID.

The method disclosed in the present disclosure may be configured such that the first and/or the second NDI values are indicated in a DCI format scheduling the PDSCH transmission. The method disclosed in the present disclosure may be configured such that the first NDI value is for the first codeword or the first transport block.

The method disclosed in the present disclosure may be configured such the second NDI value is for the second codeword or the second transport block.

The method disclosed in the present disclosure may be configured such the first HARQ-ACK information bit is the first type of HARQ-ACK information bit when the first parameter is not configured and the HARQ-ACK codebook is configured to comprise the first NDI value and/or the second NDI value.

In summary, the present disclosure provides options of HARQ-ACK feedback configuration for Type A one-shot HARQ feedback, that is NDI is configured to be part of one-shot HARQ feedback, in NR-U for the case that Type A one-shot HARQ feedback and spatial bundling for HARQ feedback are configured simultaneously. With this method, the UE can determine how to perform one-shot HARQ feedback. The technical mechanisms provided by the present disclosure could be adopted in the 5G NR unlicensed band communications.

1. A method of HARQ feedback, the method comprising:
receiving a Physical Downlink Shared Channel (PDSCH) transmission; and
transmitting a Hybrid Automatic Report Request (HARQ) feedback of the PDSCH transmission,
wherein the HARQ feedback comprises a one-shot HARQ feedback.

2. The method according to claim 1,
wherein the PDSCH transmission corresponds to a HARQ process identifier (ID).

3. The method according to claim 1,
wherein the PDSCH transmission comprises an amount of codewords or an amount of transport blocks, the amount of codewords or transport blocks comprises at least one or two.

4. The method according to claim 1,
wherein the one-shot HARQ feedback comprises an HARQ-ACK codebook,
wherein the HARQ-ACK codebook comprises at least one of the followings: a first HARQ-ACK information bit or a second HARQ-ACK information bit, and
wherein the first and/or the second HARQ-ACK information bit are for a HARQ process ID.

5. The method according to claim 4,
wherein the first HARQ-ACK information bit comprises at least one of the followings:
a first type of HARQ-ACK information bit; and
a second type of HARQ-ACK information bit,
the first type of HARQ-ACK information bit comprises an HARQ-ACK information bit for a first codeword or for a first transport block of the HARQ process ID,
the second type of HARQ-ACK information bit comprises:
a binary AND operation of an HARQ-ACK information bit for a first codeword or a first transport block of the HARQ process ID and an HARQ-ACK information bit for a second codeword or a second transport block of the HARQ process ID.

6. The method according to claim 5,
wherein the first HARQ-ACK information bit is the second type of HARQ-ACK information bit when a first parameter is configured, the first parameter is relevant to spatial bundling.

7. The method according to claim 4,
wherein the HARQ-ACK codebook may be configured to further comprise a first New Data Identifier (NDI) value and/or a second NDI value corresponding to the HARQ process ID.

8. The method according to claim 7,
wherein the first and/or the second NDI values are indicated in a DCI format scheduling the PDSCH transmission, the first NDI value is for a first codeword or a first transport block, the second NDI value is for a second codeword or a second transport block.

9. The method according to claim 5,
wherein the first HARQ-ACK information bit is the first type of HARQ-ACK information bit when a first parameter is not configured and the HARQ-ACK codebook is configured to comprise a first NDI value and/or a second NDI value.

10. The method according to claim 1,
wherein the one-shot HARQ feedback comprises at least one of the following two types:
a first type in which a NDI is part of the one-shot HARQ feedback; and
a second type in which the NDI is not part of the one-shot HARQ feedback, spatial bundling is configured for the HARQ feedback.

11. A user equipment comprising:
a receiver configured to receive a Physical Downlink Shared Channel (PDSCH) transmission; and
a transmitter configured to transmit a Hybrid Automatic Report Request (HARQ) feedback of the PDSCH transmission,
wherein the HARQ feedback comprises a one-shot HARQ feedback.

12. The user equipment according to claim 11,
wherein the one-shot HARQ feedback comprises an HARQ-ACK codebook,
wherein the HARQ-ACK codebook comprises at least one of the followings: a first HARQ-ACK information bit or a second HARQ-ACK information bit, and
wherein the first and/or the second HARQ-ACK information bit are for a HARQ process ID.

13. The user equipment according to claim 12,
wherein the first HARQ-ACK information bit comprises at least one of the followings:
a first type of HARQ-ACK information bit; and
a second type of HARQ-ACK information bit,
the first type of HARQ-ACK information bit comprises an HARQ-ACK information bit for a first codeword or for a first transport block of the HARQ process ID, the second type of HARQ-ACK information bit comprises:
a binary AND operation of an HARQ-ACK information bit for a first codeword or a first transport block of the HARQ process ID and an HARQ-ACK information bit for a second codeword or a second transport block of the HARQ process ID.

14. The user equipment according to claim 13,
wherein the first HARQ-ACK information bit is the second type of HARQ-ACK information bit when a first parameter is configured, the first parameter is relevant to spatial bundling.

15. The user equipment according to claim 12,
wherein the HARQ-ACK codebook comprises the second HARQ-ACK information bit, when a first parameter is not configured.

16. The user equipment according to claim 12,
wherein the HARQ-ACK codebook may be configured to further comprise a first New Data Identifier (NDI) value and/or a second NDI value corresponding to the HARQ process ID.

17. The user equipment according to claim 13,
wherein the first HARQ-ACK information bit is the first type of HARQ-ACK information bit when a first parameter is not configured and the HARQ-ACK codebook is configured to comprise a first NDI value and/or a second NDI value.

18. The user equipment according to claim 11,
wherein the one-shot HARQ feedback comprises at least one of the following two types:
a first type in which a NDI is part of the one-shot HARQ feedback; and
a second type in which the NDI is not part of the one-shot HARQ feedback, spatial bundling is configured for the HARQ feedback.

19. The user equipment according to claim 11,
wherein a configuration of spatial bundling does not apply to types of one-shot HARQ feedback in which the NDI is part of the one-shot HARQ feedback.

20. A method of HARQ feedback, the method comprising:
transmitting a Physical Downlink Shared Channel (PDSCH) transmission; and
receiving a Hybrid Automatic Report Request (HARQ) feedback of the PDSCH transmission,
wherein the HARQ feedback comprises a one-shot HARQ feedback.

21. The method according to claim 20,
wherein the PDSCH transmission corresponds to a HARQ process identifier (ID); or
the PDSCH transmission comprises an amount of codewords or an amount of transport blocks, and the amount of codewords or transport blocks comprises at least one or two.

22. The method according to claim 20,
wherein the one-shot HARQ feedback comprises an HARQ-ACK codebook, the HARQ-ACK codebook comprises at least one of the followings: a first HARQ-ACK information bit or a second HARQ-ACK information bit, and the first and/or the second HARQ-ACK information bit are for a HARQ process ID; or
the one-shot HARQ feedback comprises at least one of the following two types:
a first type in which a NDI is part of the one-shot HARQ feedback; and
a second type in which the NDI is not part of the one-shot HARQ feedback, spatial bundling is configured for the HARQ feedback.

23. The method according to claim 22,
wherein the first HARQ-ACK information bit comprises at least one of the followings:
a first type of HARQ-ACK information bit; and
a second type of HARQ-ACK information bit,
the first type of HARQ-ACK information bit comprises an HARQ-ACK information bit for a first codeword or for a first transport block of the HARQ process ID,
the second type of HARQ-ACK information bit comprises:
a binary AND operation of an HARQ-ACK information bit for a first codeword or a first transport block of the HARQ process ID and an HARQ-ACK information bit for a second codeword or a second transport block of the HARQ process ID; or
the HARQ-ACK codebook comprises the second HARQ-ACK information bit, when a first parameter is not configured; or
the HARQ-ACK codebook may be configured to further comprise a first New Data Identifier (NDI) value and/or a second NDI value corresponding to the HARQ process ID.

24. The method according to claim 23,
wherein the first HARQ-ACK information bit is the second type of HARQ-ACK information bit when a first parameter is configured, the first parameter is relevant to spatial bundling; or
the first HARQ-ACK information bit is the first type of HARQ-ACK information bit when a first parameter is not configured and the HARQ-ACK codebook is configured to comprise a first NDI value and/or a second NDI value.

25. The method according to claim 20,
wherein a configuration of spatial bundling does not apply to types of one-shot HARQ feedback in which the NDI is part of the one-shot HARQ feedback.
